(19) United States
(12) Patent Application Publication
(10) Pub. No.: US 2011/0050117 A1
(43) Pub. Date: Mar. 3, 2011

(54) Integrated circuit module having a display device

(75) Inventor: Hong-Chi Yu, Kaohsiung City (TW)

(73) Assignee: WALTON ADVANCED ENGINEERING INC., Kaohsiung City (TW)

(21) Appl. No.: 12/585,865

(22) Filed: Sep. 28, 2009

(30) Foreign Application Priority Data
Aug. 31, 2009 (TW) 098129211

(51) Int. Cl. H05B 37/02

(52) U.S. Cl. 315/291

(57) ABSTRACT

An IC module having a display device includes an IC module, a power supply device and at least a display panel. The IC module has a substrate, at least an IC chip and a package. The power supply device has a magnetic block, a circuit board, a housing and a coil. At least a capacitor is mounted on the circuit board. Besides, the display panel is mounted on an outer surface of the housing. Given the aforementioned components, when those components are shaken back and forth, the magnetic block is moved back and forth in the coil to make the coil generate power. The generated power is further stored in the capacitor of the circuit board. As such, after acquiring power, the display panel displays the information in association with the IC module.

### FIELD OF THE INVENTION

The present invention relates to an integrated circuit (IC) module having a display device, and more particularly to an IC module having display device powered by an electromagnetic induction device.

### BACKGROUND OF THE INVENTION

To keep abreast with constant evolvement of information technology, demands of users toward data storage seem to be an endless pursuit. In addition to data storage devices complying with the requirement of being light, thin, short and compact, storage capacity has also migrated from the conventional 1.44 MB floppy diskette to large-capacity data storage device in gigabytes (GB). Although the storage capacity of the present data storage devices, e.g. flash drive, hard drive, DVD disc and so forth, has significantly upgraded, if the demand trend of users toward storage capacity is a concern, the issue of insufficient storage capacity will still inevitably bother users in the future. As far as operational habit is concerned, users normally connect data storage devices to a power supply device, e.g. computer equipment, and confirm the capacity of data storage device only after the power is on. After the capacity is confirmed, users can then determine if the capacity is sufficient for users to store data. Such process not only results in users' inconvenience but also wastes energy. Hence, how to confirm the capacity of data storage devices conveniently, quickly and easily and save energy is indeed a critical subject.

Speaking of common energy in use, power supply device of computer equipment is one of those usually adopted to charge the rechargeable battery inside electronic products. Nowadays, a series of energy-saving solutions emerge one after the other as a result of the influence of energy conservation, and solar charging is one solution among them. However, solar charging is prone to environmental influence, leading to be inconvenient in operation, because solar charger may provide sufficient power in a sunny occasion and poor power in a dark occasion. Therefore, how to provide a stable power supply device could be a very critical issue.

### SUMMARY OF THE INVENTION

To solve the foregoing issue, a main objective of the present invention is to provide an IC module having a display device in which a power supply device thereof capable of generating power by electromagnetic induction is electrically connected with the IC module and the display panel. Given the aforementioned components, when the IC module having the display device is shaken back and forth, the power supply device generates power, and the display panel displays information in association with the IC module after acquiring power, thereby providing information relevant to capacity and the like of the IC module in a convenient, fast and simple fashion to users.

Another objective of the present invention is to provide an IC module having a display device that a power supply device thereof capable of generating power by electromagnetic induction is electrically connected with the IC module and the display panel. Given the aforementioned components, when the IC module having the display device is shaken back and forth, the power supply device generates power and the display panel displays information in association with the IC module after acquiring power. As the present invention does not require the power supply of other power supply device such as computer equipment, the power-saving efficacy can be also achieved.

To achieve the above-mentioned objectives, a main technical measure employed by the present invention is realized by the following solution.

An IC module having a display device includes an IC module, a power supply device and at least a display panel. The IC module has a substrate, at least one IC chip and a package. The substrate has an inner surface and an outer surface. The at least one IC chip is mounted on the inner surface of the substrate (11). The package seals the IC chip.

The power supply device has a magnetic block, a circuit board, a housing and a coil and is electrically connected with the IC module. The magnetic block is mounted inside the coil to move back and forth therein. The circuit board has at least one capacitor. The coil is received in the housing and connected with the circuit board.

The display panel is mounted on an outer surface of the housing. At least one first terminal is mounted on an inner surface of the display panel and connected with a second terminal mounted on the outer surface of the housing so as to electrically connect with the circuit board.

The magnetic block is moved back and forth in the coil to make the coil generate power when the IC module having a display device is moved back and forth. The power is stored by the capacitor of the circuit board. The display panel displays information in association with the IC module after acquiring power.

The objectives and solution of the present invention can be further realized by the following technical measure.

Preferably, a plurality of metal contacts are mounted on the outer surface of the substrate and are electrically connected with the substrate, the IC module has a socket connected with a plug so that the IC module is electrically connected with the power supply device, a switch is mounted on one side of the circuit board and protruded beyond an outer surface of the housing, the display panel acquires power and displays the information in association with the IC module after the switch is switched on.

Preferably, the metal contacts are compatible with an USB transmission interface.

Preferably, the metal contacts are compatible with a Mini USB transmission interface.

Preferably, the metal contacts are compatible with a Micro USB transmission interface.

Preferably, the metal contacts are compatible with an e-SATA transmission interface.

Preferably, the housing has a chamber, an opening is formed through one end of the housing to communicate with the chamber, the IC module is received in the chamber, a plurality of metal contacts are mounted on the outer surface of the substrate and are electrically connected with the substrate, a plurality of stranded wires are received in the chamber and located at another end opposite to the opening, the stranded wires are electrically connected to the substrate and the IC module.

Preferably, a switch is mounted to one side of the circuit board, a side edge of the switch is protruded beyond an outer surface of the housing, and after the switch is switched on, the display panel acquires power and displays the information in association with the IC module.

Preferably, at least one snap hole is formed on a side surface of the IC module, the housing has a through slot corresponding to the snap hole and extended toward two ends of the housing, the housing has a shifting block penetrating through the through slot to connect with the snap hole of the IC module, and when the shifting block is moved along the through slot, the IC module is protruded beyond the housing.

Preferably, the metal contacts are compatible with a USB transmission interface.

Preferably, the metal contacts are compatible with a Mini USB transmission interface.

Preferably, the metal contacts are compatible with a Micro USB transmission interface.

Preferably, the metal contacts are compatible with an e-SATA transmission interface.

Preferably, a plurality of metal contacts are mounted on the outer surface of the substrate and are electrically connected with the substrate, the IC module has a casing enclosing the IC module and an electrical connector formed on the casing to correspond to those metal contacts, the IC module has a socket connected with a plug of the housing so that the power supply device is electrically connected with the IC module, a switch is mounted to one side of the circuit board, a side edge of the switch is protruded beyond an outer surface of the housing, and after the switch is switched on, the display panel acquires power and displays the status information in association with the IC module.

Preferably, the metal contacts are compatible with a USB transmission interface, and the electrical connector is a USB plug.

Preferably, the metal contacts are compatible with a Mini USB transmission interface, and the electrical connector is a Mini USB plug.

Preferably, the metal contacts are compatible with a Micro USB transmission interface, and the electrical connector is a Micro USB plug.

Preferably, the metal contacts are compatible with an e-SATA transmission interface, and the electrical connector is an e-SATA plug.

Preferably, the housing has a chamber, an opening is formed through one end of the housing to communicate with the chamber, the IC module is received in the chamber, a plurality of metal contacts are mounted on the outer surface of the substrate and are electrically connected with the substrate, the IC module has a casing enclosing the IC module and an electrical connector formed on the casing to correspond to those metal contacts, a plurality of stranded wires are received in the chamber and located at another end opposite to the opening, and the stranded wires are electrically connected to the substrate and the IC module.

Preferably, a switch is mounted to one side of the circuit board, a side edge of the switch is protruded beyond an outer surface of the housing, and after the switch is switched on, the display panel acquires power and displays the information in association with the IC module.

Preferably, at least one snap hole is formed on a side surface of the IC module, the housing has a through slot corresponding to the snap hole and extended toward two ends of the housing, the housing has a shifting block penetrating through the through slot to connect with the snap hole of the IC module, and when the shifting block is moved along the through slot, the IC module is protruded beyond the housing.

Preferably, the metal contacts are compatible with a USB transmission interface, and the electrical connector is a USB plug.

Preferably, the metal contacts are compatible with a Mini USB transmission interface, and the electrical connector is a Mini USB plug.

Preferably, the metal contacts are compatible with a Micro USB transmission interface, and the electrical connector is a Micro USB plug.

Preferably, the metal contacts are compatible with an e-SATA transmission interface, and the electrical connector is an e-SATA plug.

Preferably, the IC module is a memory module.

Preferably, the information displayed by the display panel is at least one of total capacity, used capacity, percentage of used capacity, available capacity, percentage of available capacity, a perpetual calendar and current date and time.

In contrast to conventional technique, the present invention mainly employs the power supply device electrically connected with the IC module and the display panel so that the power supply device generates power by shaking the components back and forth. After acquiring power, the display panel displays status information in association with the IC module. Therefore, users understand the information relevant to capacity and the like of the IC module in a convenient, fast and simple fashion, and the present invention does not require power from other power supply device such as computer equipment or a battery to further achieve the power-saving efficacy.

The foregoing and other features and advantages of the present invention will be more clearly understood through the following descriptions with reference to the drawing, wherein:

### BRIEF DESCRIPTION OF THE DRAWINGS

FIG. 1 is an exploded view of a first preferred embodiment of an IC module having a display device in accordance with the present invention;

FIG. 2 is a cross-sectional view in FIG. 1;

FIG. 3 is another cross-sectional view in FIG. 1;

FIG. 4 is an exploded view of a second preferred embodiment of an IC module having a display device in accordance with the present invention;

FIG. 5 is a cross-sectional view in FIG. 4;

FIG. 6 is another cross-sectional view in FIG. 4;

FIG. 7 is an exploded view of a third preferred embodiment of an IC module having a display device in accordance with the present invention;

FIG. 8 is a cross-sectional view in FIG. 7;

FIG. 9 is another cross-sectional view in FIG. 7;

FIG. 10 is an exploded view of a fourth preferred embodiment of an IC module having a display device in accordance with the present invention;

FIG. 11 is a cross-sectional view in FIG. 10; and

FIG. 12 is another cross-sectional view in FIG. 10.

### DETAILED DESCRIPTION OF THE PREFERRED EMBODIMENT

It is to be noted that the following descriptions of preferred embodiments of this invention are presented herein for purpose of illustration and description only; it is not intended to be exhaustive or to be limited to the precise form disclosed.

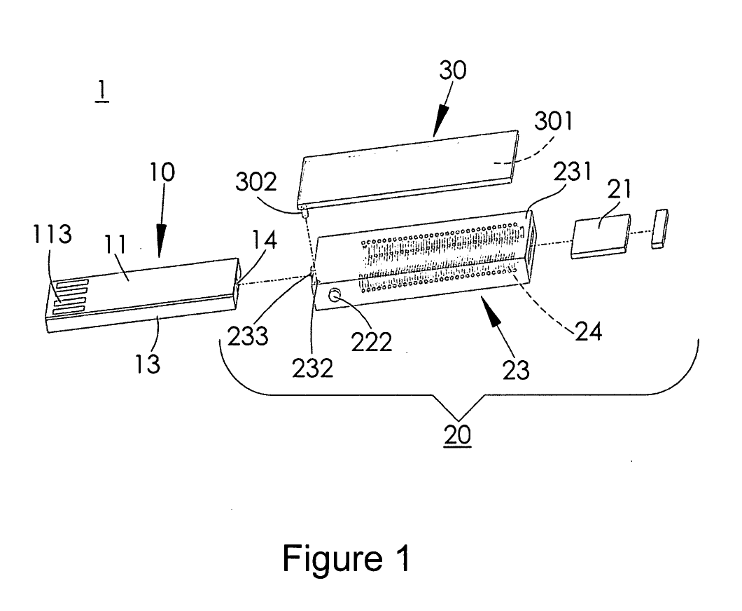

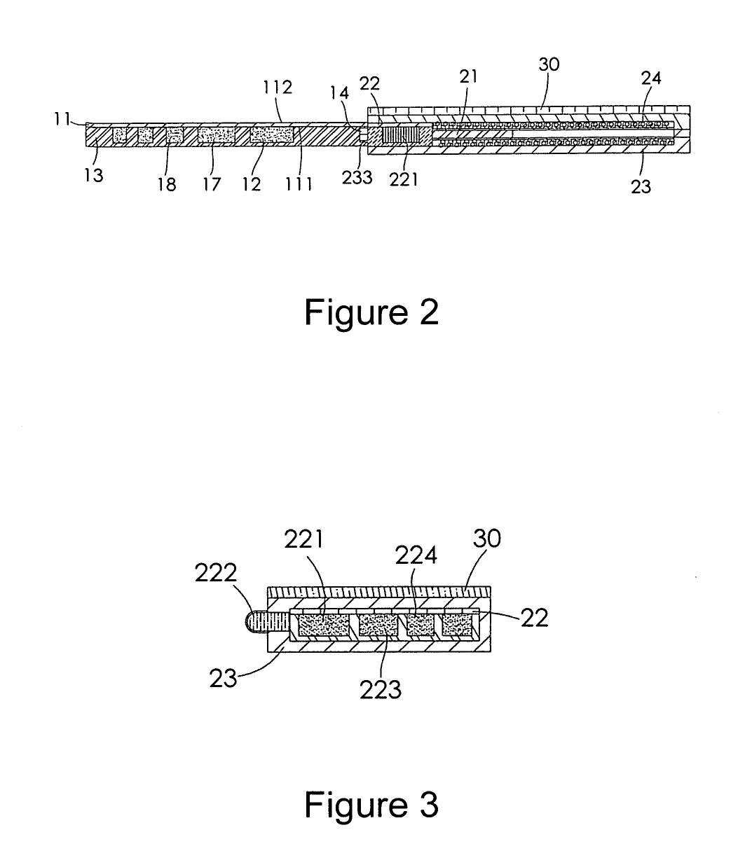

With reference to FIGS. 1, 2 and 3, an IC module having a display device (1) pertaining to a first preferred embodiment of the present invention is shown. The IC module having a display device (1) includes an IC module (10), a power supply device (20) and at least a display panel (30).

The IC module (10) has a substrate (11), at least one IC chip (12) and a package (13) for this module. The substrate (11) serves as a chip carrier and transmission interface and has an inner surface (111) and an outer surface (112). Circuits (not shown) are formed in the substrate (11). The at least one IC chip is mounted on the inner surface (111) and is electrically connected with the substrate (11) by wire bonding or flip-chip bonding. Normally, the IC chip (12) can be a flash memory, a static random access memory (SRAM), an application-specific-integrated-circuit (ASIC) or a synchronous dynamic random access memory (SDRAM).

In the present embodiment, components mounted on the inner surface (111) of the substrate (11) further include at least one active component (17) and at least one passive component (18). The active component (17) is electrically connected with the IC chip (12), the power supply device (20) and the display panel (30). The active component (17) can be integrated with the IC chip (12) to form a system-on-chip (SOC). The active component (17) can also control the accessing operation of the IC chip (12). The package (13) is used to seal the IC chip (12) by molding or lithography.

The power supply device (20) has a magnetic bock (21), a circuit board (22), a housing (23) and a coil (24). The coil (24) is received in the housing and the magnetic block (21) is mounted inside the coil (24) so that the magnetic block (21) can be moved back and forth inside the coil (24). The coil (24) is connected with the circuit board (22) and is electrically connected therewith. At least one capacitor (221), at least one active component (223) and at least one passive component (224) are mounted on the circuit board (22). Therefore, when the magnetic block (21) is moved back and forth inside the coil (24), electric power is generated by electromagnetic induction and is stored in the capacitor (221) of the circuit board (22).

The IC module (10) has a socket (14). The housing (23) of the power supply device (20) has a plug (223). The socket (14) and the plug (233) are electrically connected so that the power supply device (20) is electrically connected with the IC module (10). The way of the power supply device (20) electrically connected with the IC module (10) is not limited to the plug-in means mentioned by the present invention. Any other connection means commonly adopted by the industry such as joggling, riveting, locking, snap-fitting, insert-molding and the like can be employed as wished.

Besides, the display panel (30) is mounted on an outer surface (231) of the housing (23). At least one first terminal (302) is mounted on an inner surface (301) of the display panel (30). The first terminal (302) is connected with a second terminal (232) on an outer surface (231) of the housing (23) and is electrically connected with the circuit board (22). A switch (222) is mounted to one side of the circuit board (22) and is electrically connected with the circuit board (22). A side edge of the switch (222) is protruded beyond an outer surface of the. housing (23). After the switch (222) is switched on, the active component (223) of the circuit board (22) requests the active component (17) of the substrate (11) to provide information in association with the IC module (10). After acquiring the information, the active component (223) of the circuit board transmits the information to the display panel (30).

A plurality of metal contacts (113) are mounted on an outer surface (112) of the substrate (11) to electrically connect with the substrate (11). In the present embodiment, these metal contacts (113) may pertain to a transmission interface compatible with any one of USB (Universal Serial Bus), Mini USB, Micro USB and e-SATA (External Serial ATA). The concept of the present invention can be also adopted to connectors with other specifications to have the efficacy of the present invention. The IC module (10) may be a memory module. The information displayed on the display panel (30) contains at least one of total capacity, used capacity, percentage of used capacity, available capacity, percentages of available capacity, a perpetual calendar or a current date and time. Certainly, the displayed status information is not just limited to those mentioned. Regardless of information relevant to the IC module (10) such as last file opened, last file saving date, size of last file saved and last revision date, they can be randomly selected based on user's operational concern.

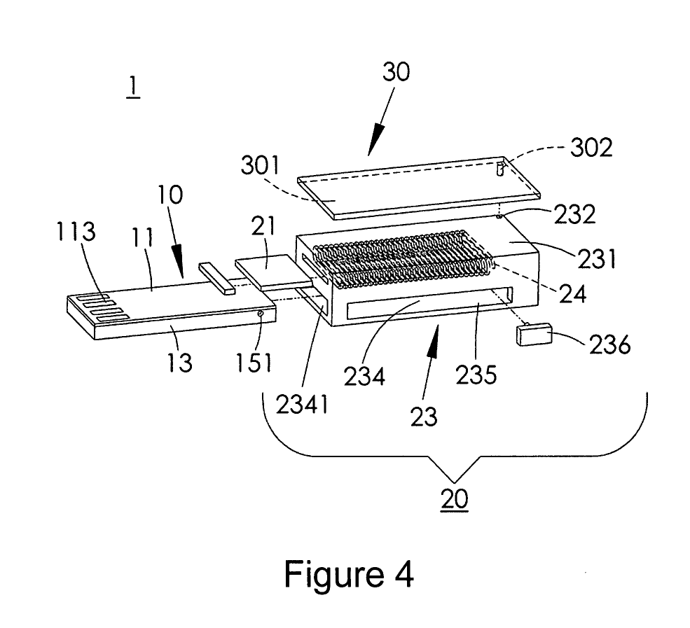

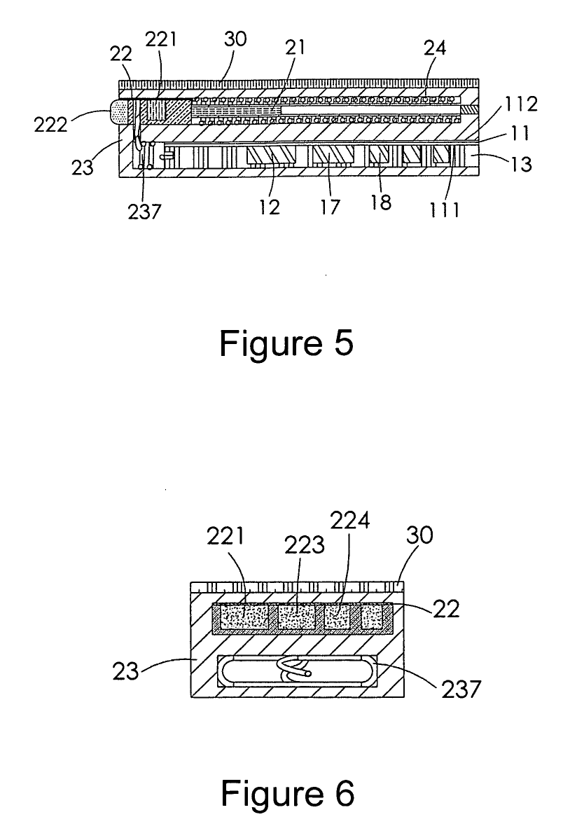

With reference to FIGS. 4, 5 and 6, an IC module having a display device of a second pertaining to a second preferred embodiment of the present invention is shown. Components in FIGS. 4, 5 and 6 similar to those components of the IC module having a display device of the first preferred embodiment in accordance with the present invention as shown in FIGS. 1, 2 and 3 are marked with the identical reference numerals and are not repeated here. The housing (23) has a chamber (23) and an opening (2341) is formed through one end of the housing (23) to communicate with the chamber (234). The IC module (10) is received in the chamber (234). A plurality of stranded wires (237) are received in the chamber (234) and located at another end opposite to the opening (2341). These stranded wires (237) are electrically connected to the substrate (11) and the IC module (10). At least one snap hole (151) is formed on a side surface (13) of the IC module (10). The housing (23) has a through slot (235) corresponding to the snap hole (151) and extended toward two ends of the housing (23). The housing (23) has a shifting bock (236) penetrating through the through slot (235) to connect with the snap hole (151) of the IC module. When the shifting block (236) is moved along the through slot (235), the IC module (10) is protruded beyond the housing (23).

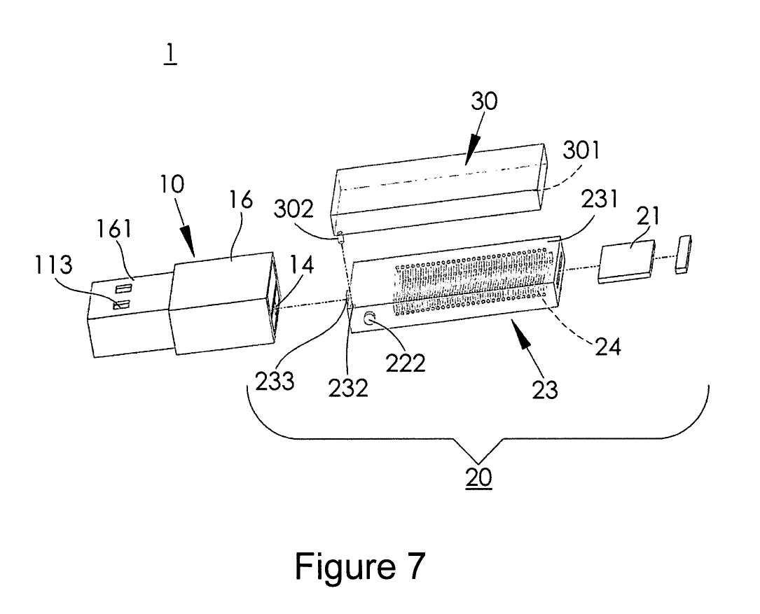

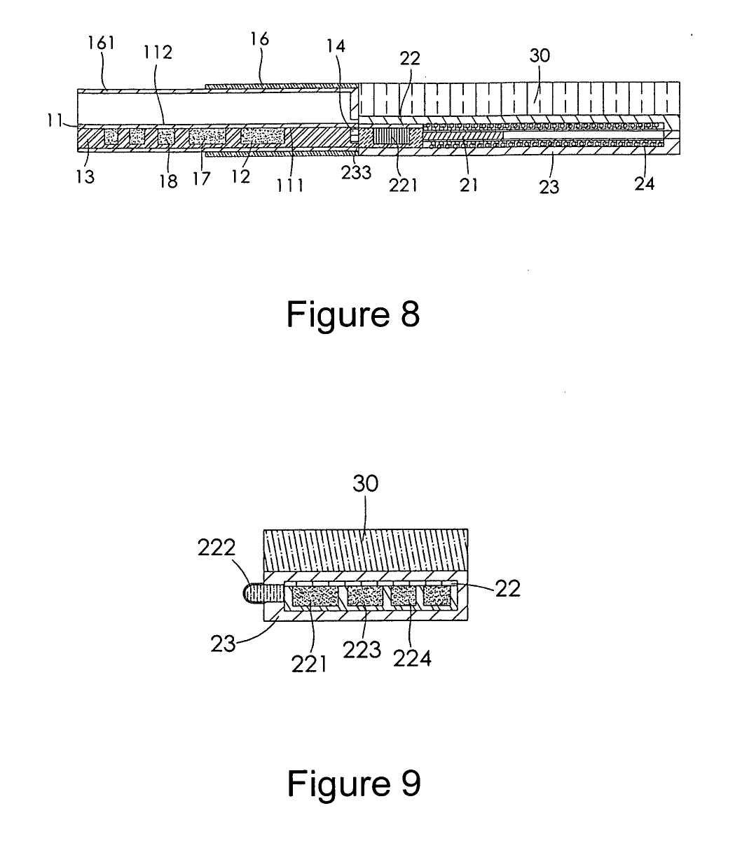

With reference to FIGS. 7, 8 and 9, an IC module having a display device pertains to a third preferred embodiment of the present invention. Components in FIGS. 7, 8 and 9 similar to those components of the IC module having a display device of the first preferred embodiment in accordance with the present invention as shown in FIGS. 1, 2 and 3 are marked with the identical reference numerals and are not repeated here. The present embodiment differs from the first embodiment in that the IC module (10) of the present embodiment has a casing (16) enclosing the IC module (10) and an electrical connector (161) formed on the casing (16) to correspond to those metal contacts (113). The electrical connector (161) is a USB connector, a Mini USB connector, a Micro USB connector or an e-SATA connector when the metal contacts (113) are compatible with a USB transmission interface, a Mini USB transmission interface, a Micro USB transmission interface or an e-SATA transmission interface.

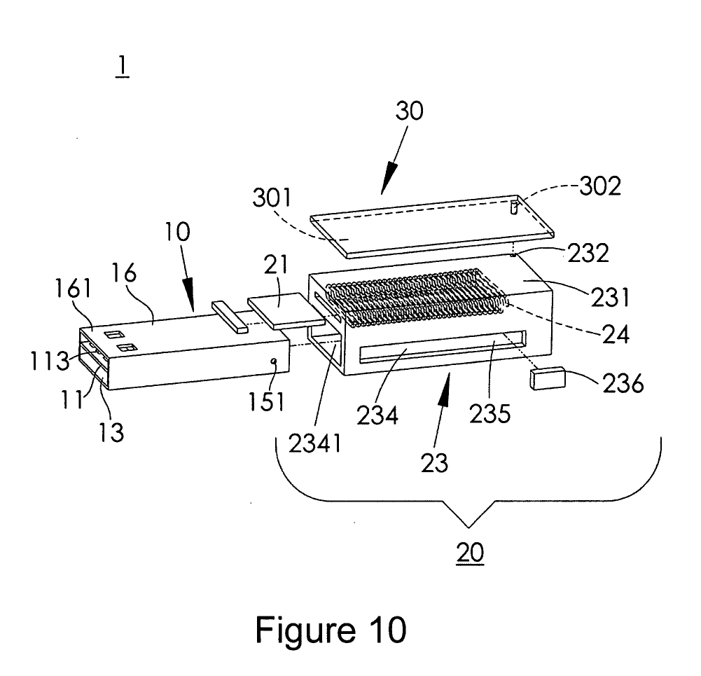

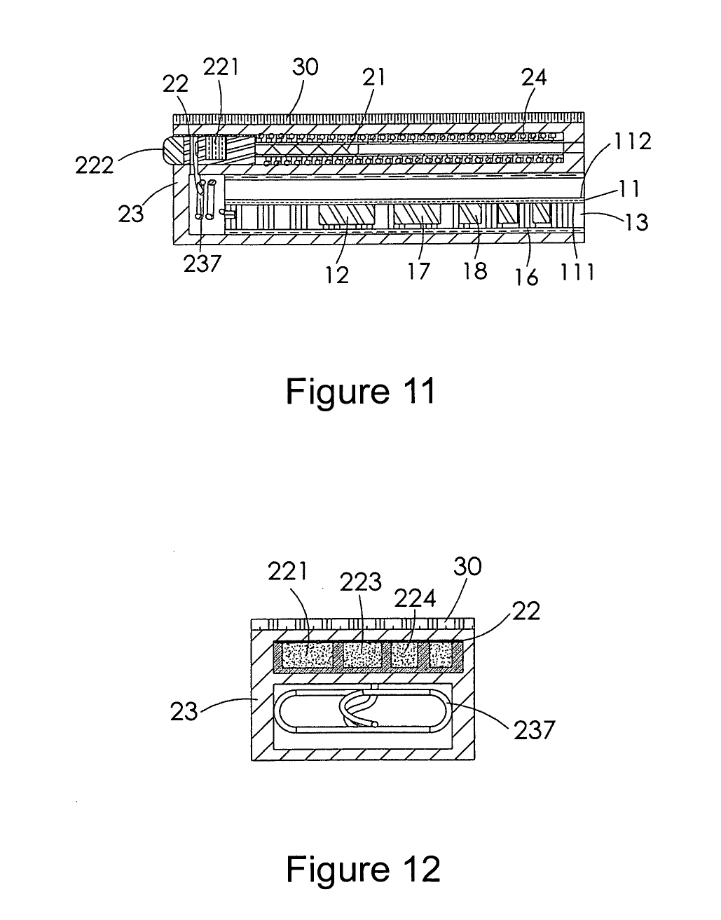

With reference to FIGS. 10, 11 and 12, an IC module having a display device pertaining to a fourth preferred embodiment of the present invention is shown. Components in FIGS. 10, 11 and 12 similar to those of the IC module having a display device of the first preferred embodiment in accordance with the present invention as shown in FIGS. 4, 5 and 6 are marked with the identical reference numerals and are not repeated here. The present embodiment differs from the second embodiment in that the IC module (10) of the present embodiment has a casing (16) enclosing the IC module (10) and an electrical connector (161) formed on the casing (16) to correspond to those metal contacts (113). The electrical connector (161) is a USB connector, a Mini USB connector, a Micro USB connector or an e-SATA connector when the metal contacts (113) are compatible with the USB transmission interface, the Mini USB transmission interface, the Micro USB transmission interface or the e-SATA transmission interface.

In sum, the present invention employs electrical connection among the power supply device generating power by electromagnetic induction, the IC module and the display panel to let the power supply device generate power when those components are shaken back and forth. After acquiring power, the display panel displays the information in associated with the IC module. As a result, the advantages of the present invention are concluded as:

Convenient, fast and simple operation: Users are allowed to know the information pertinent to the capacity of the IC module and the like in a convenient, fast and easy fashion.

Energy saving: The present invention acquires the information in association with the IC module without requiring power from other power supply device such as the power supply of computer equipment, to further achieve the energy-saving efficacy.

As such, the present invention differs from conventional devices having IC modules and thus provides the practical and innovative value to the industry, and the application is hereby submitted in accordance with the patent laws.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An IC module having a display device, comprising:
an IC module having a substrate having an inner surface and an outer surface, at least one IC chip mounted on the inner surface of the substrate, and a package for sealing the IC chip;
a power supply device electrically connected with the IC module and having a circuit board having at least one capacitor, a housing, a coil received in the housing and connected with the circuit board and a magnetic block mounted inside the coil to move back and forth therein;
at least a display panel mounted on an outer surface of the housing and having at least one first terminal mounted on an inner surface of the display panel and connected with a second terminal mounted on the outer surface of the housing so as to be electrically connect with the circuit board;
whereby the magnetic block is moved back and forth in the coil to make the coil generate power then the generated power is stored in the capacitor of the circuit board, and the display panel displays information in association with the IC module after acquiring power.

2. The IC module having a display device as claimed in claim 1, wherein a plurality of metal contacts are mounted on the outer surface of the substrate and are electrically connected with the substrate, the IC module has a socket connected with a plug so that the IC module is electrically connected with the power supply device, a switch is mounted on one side of the circuit board and protruded beyond an outer surface of the housing, the display panel acquires power and displays the information in association with the IC module after the switch is switched on.

3. The IC module having a display device as claimed in claim 2, wherein the metal contacts are compatible with a USB transmission interface.

4. The IC module having a display device as claimed in claim 2, wherein the metal contacts are compatible with a Mini USB transmission interface.

5. The IC module having a display device as claimed in claim 2, wherein the metal contacts are compatible with a Micro USB transmission interface.

6. The IC module having a display device as claimed in claim 2, wherein the metal contacts are compatible with an e-SATA transmission interface.

7. The IC module having a display device as claimed in claim 1, wherein the housing has a chamber, an opening is formed through one end of the housing to communicate with the chamber, the IC module is received in the chamber, a plurality of metal contacts are mounted on the outer surface of the substrate and are electrically connected with the substrate, a plurality of stranded wires are received in the chamber and located at another end opposite to the opening, the stranded wires are electrically connected to the substrate and the IC module.

8. The IC module having a display device as claimed in claim 7, wherein a switch is mounted to one side of the circuit board, a side edge of the switch is protruded beyond an outer surface of the housing, and after the switch is switched on, the display panel acquires power and displays the information in association with the IC module.

9. The IC module having a display device as claimed in claim 7, wherein at least one snap hole is mounted on a side surface of the IC module, the housing has a through slot corresponding to the snap hole and extended toward two ends of the housing, the housing has a shifting bock penetrating through the through slot to connect with the snap hole of the IC module, and when the shifting block is moved along the through slot, the IC module is protruded beyond the housing.

10. The IC module having a display device as claimed in any one of claims 7, wherein the metal contacts are compatible with a USB transmission interface.

11. The IC module having a display device as claimed in any one of claims 8, wherein the metal contacts are compatible with a USB transmission interface.

12. The IC module having a display device as claimed in any one of claims 9, wherein the metal contacts are compatible with a USB transmission interface.

13. The IC module having a display device as claimed in any one of claims 7, wherein the metal contacts are compatible with a Mini USB transmission interface.

14. The IC module having a display device as claimed in any one of claims 8, wherein the metal contacts are compatible with a Mini USB transmission interface.

15. The IC module having a display device as claimed in any one of claims 9, wherein the metal contacts are compatible with a Mini USB transmission interface.

16. The IC module having a display device as claimed in any one of claims 7, wherein the metal contacts are compatible with a Micro USB transmission interface.

17. The IC module having a display device as claimed in any one of claims 8, wherein the metal contacts are compatible with a Micro USB transmission interface.

18. The IC module having a display device as claimed in any one of claims 9, wherein the metal contacts are compatible with a Micro USB transmission interface.

19. The IC module having a display device as claimed in any one of claims 7, wherein the metal contacts are compatible with an e-SATA transmission interface.

20. The IC module having a display device as claimed in any one of claims 8, wherein the metal contacts are compatible with an e-SATA transmission interface.

21. The IC module having a display device as claimed in any one of claims 9, wherein the metal contacts are compatible with an e-SATA transmission interface.

22. The IC module having a display device as claimed in claim 1, wherein a plurality of metal contacts are mounted on the outer surface of the substrate and are electrically connected with the substrate, the IC module has a casing enclosing the IC module and an electrical connector formed on the casing to correspond to those metal contacts, the IC module has a socket connected with a plug of the housing so that the power supply device is electrically connected with the IC module, a switch is mounted to one side of the circuit board, a side edge of the switch is protruded beyond an outer surface of the housing, and after the switch is switched on, the display panel acquires power and displays the information in association with the IC module.

23. The IC module having a display device as claimed in claim 22, wherein the metal contacts are compatible with a USB transmission interface, and the electrical connector is a USB plug.

24. The IC module having a display device as claimed in claim 22, wherein the metal contacts are compatible with a Mini USB transmission interface, and the electrical connector is a Mini USB plug.

25. The IC module having a display device as claimed in claim 22, wherein the metal contacts are compatible with a Micro USB transmission interface, and the electrical connector is a Micro USB plug.

26. The IC module having a display device as claimed in claim 22, wherein the metal contacts are compatible with an e-SATA transmission interface, and the electrical connector is an e-SATA plug.

27. The IC module having a display device as claimed in claim 1, wherein the housing has a chamber, an opening is formed through one end of the housing to communicate with the chamber, the IC module is received in the chamber, a plurality of metal contacts are mounted on the outer surface of the substrate and are electrically connected with the substrate, the IC module has a casing enclosing the IC module and an electrical connector formed on the casing to correspond to those metal contacts, a plurality of stranded wires are received in the chamber and located at another end opposite to the opening, and the stranded wires are electrically connected to the substrate and the IC module.

28. The IC module having a display device as claimed in claim 27, wherein a switch is mounted to one side of the circuit board, a side edge of the switch is protruded beyond an outer surface of the housing, and after the switch is switched on, the display panel acquires power and displays the information in association with the IC module.

29. The IC module having a display device as claimed in claim 27, wherein at least one snap hole is formed on a side surface of the IC module, the housing has a through slot corresponding to the snap hole and extended toward two ends of the housing, the housing has a shifting bock penetrating through the through slot to connect with the snap hole of the IC module, and when the shifting block is moved along the through slot, the IC module is protruded beyond the housing.

30. The IC module having a display device as claimed in any one of claims 27, wherein the metal contacts are compatible with a USB transmission interface, and the electrical connector is a USB plug.

31. The IC module having a display device as claimed in any one of claims 28, wherein the metal contacts are compatible with a USB transmission interface, and the electrical connector is a USB plug.

32. The IC module having a display device as claimed in any one of claims 29, wherein the metal contacts are compatible with a USB transmission interface, and the electrical connector is a USB plug.

33. The IC module having a display device as claimed in any one of claims 27, wherein the metal contacts are compatible with a Mini USB transmission interface, and the electrical connector is a Mini USB plug.

34. The IC module having a display device as claimed in any one of claims 28, wherein the metal contacts are compatible with a Mini USB transmission interface, and the electrical connector is a Mini USB plug.

35. The IC module having a display device as claimed in any one of claims 29, wherein the metal contacts are compatible with a Mini USB transmission interface, and the electrical connector is a Mini USB plug.

36. The IC module having a display device as claimed in any one of claims 27, wherein the metal contacts are compatible with a Micro USB transmission interface, and the electrical connector is a Micro USB plug.

37. The IC module having a display device as claimed in any one of claims 28, wherein the metal contacts are compatible with a Micro USB transmission interface, and the electrical connector is a Micro USB plug.

38. The IC module having a display device as claimed in any one of claims 29, wherein the metal contacts are compatible with a Micro USB transmission interface, and the electrical connector is a Micro USB plug.

39. The IC module having a display device as claimed in any one of claims 27, wherein the metal contacts are compatible with an e-SATA transmission interface, and the electrical connector is an e-SATA plug.

40. The IC module having a display device as claimed in any one of claims 28, wherein the metal contacts are compatible with an e-SATA transmission interface, and the electrical connector is an e-SATA plug.

41. The IC module having a display device as claimed in any one of claims 29, wherein the metal contacts are compatible with an e-SATA transmission interface, and the electrical connector is an e-SATA plug.

42. The IC module having a display device as claimed in claim 1, wherein the IC module is a memory module.

43. The IC module having a display device as claimed in claim 1, wherein the information displayed by the display panel is at least one of total capacity, used capacity, percentage of used capacity, available capacity, percentage of available capacity, a perpetual calendar or a current date and time.
